(19) United States
(12) Patent Application Publication
(10) Pub. No.: US 2024/0418974 A1
(43) Pub. Date: Dec. 19, 2024

(54) METHOD, LIGHT MICROSCOPE AND COMPUTER PROGRAM FOR LOCALIZING OR TRACKING AN EMITTER

(71) Applicant: ABBERIOR INSTRUMENTS GMBH, Gottingen (DE)

(72) Inventors: Matthias REUSS, Gottingen (DE); Winfried WILLEMER, Bovenden (DE)

(21) Appl. No.: 18/742,434

(22) Filed: Jun. 13, 2024

(30) Foreign Application Priority Data
Jun. 14, 2023 (DE) 10 2023 115 483.4

(51) Int. Cl. G02B 21/00

(52) U.S. Cl. CPC G02B 21/0084; G02B 21/0028; G02B 21/0048; G02B 21/0076

(57) ABSTRACT

The present disclosure relates to a method for localizing or tracking an emitter in a sample, wherein the sample is illuminated with an intensity distribution of illumination light comprising a local intensity minimum, wherein the illumination light affects light emissions of the emitter, and wherein the intensity distribution is displaced on a path around a presumed position of the emitter, wherein light emissions of the emitter are detected in a time-resolved manner in a measurement time interval in order to obtain an emission signal, and wherein a position of the emitter in the sample is estimated based on a temporal modulation of the emission signal caused by the displacement of the intensity distribution on the path, as well as a light microscope (1) and a computer program for performing the method.

### CROSS-REFERENCE TO RELATED APPLICATIONS

The present application claims the benefit of and priority to German Patent Application Serial No. 10 2023 115 483.4, filed Jun. 14, 2023, the entire contents of which is incorporated herein by reference.

### TECHNICAL FIELD

The present specification relates to a method for localizing or tracking an emitter in a sample as well as a light microscope and a computer program for performing the method.

### PRIOR ART

A method for determining the position of an emitter in a sample and for tracking an emitter in a sample using a focused illumination light whose Gaussian focus is displaced along a path around an emitter is known in the prior art and is now referred to as the “orbital method” or, depending on the application, as “orbital tracking” or “orbital scanning”.

Such a method is proposed in the publication “Tracking of fluorescent molecules diffusing within membranes” (Jörg Enderlein, Appl. Phys. B 71, 773-777 (2000); DOI: 10.1007/s003400000409) and further explained in the publication “Positional and Temporal Accuracy of Single Molecule Tracking” (Jörg Enderlein, Single Mol., 1:225-230. https://doi.org/10.1002/1438-5171). In this method, a laser beam is focused in the plane of motion of the molecule to be observed. The laser focus is moved along a circular path with a fixed radius. The same applies to the focal point of the confocal detection. After each revolution, the center of the circle is adjusted to a new position according to the photon detection intensities observed along the circular path, wherein the direction of the adjustment is determined optimally and the radial displacement is simply approximated. In the latter publication, the achievable accuracy of a position determination of a fluorophore at rest, i.e. a localization, is discussed. The method can reportedly be realized using commercially available piezo scanners and piezo tables.

In the publication “Scanning FCS, a novel method for three-dimensional particle tracking” (Levi V. et al., Biochem Soc Trans. 2003 October; 31 (Pt 5): 997-1000. doi: 10.1042/bst0310997. PMID: 14505467) describes a method based on the principle of orbital tracking. A Gaussian laser focus is used for two-photon excitation of fluorescence. It is guided alternately on two circular paths, each around a center on an optical axis, with one center above and the other below the particle to be tracked. The focus is shifted along the circular path using a galvo scanner. The difference between the fluorescence signals averaged over several orbits is used to determine the axial position of the particle. The lateral position of the particle is determined by determining a signal profile from several orbits, depending on the signal level, around a center, which is analyzed using a fast Fourier transformation (FFT). The resulting phase of the fundamental frequency, the “AC term”, corresponds directly to the angular coordinate of the position of the observed particle, while the radial distance of the position of the particle to the orbit axis can reportedly be determined from the ratio of the DC component, referred to as “DC”, to the “AC term”, i.e. from the modulation “AC/DC”.

The same measurement principle is used in the publication “3-D Particle Tracking in a Two-Photon Microscope: Application to the Study of Molecular Dynamics in Cells” (Levi V. et al., Biophys. J 88 (2005) 2919-2928).

In the publication “Distance Measurement by Circular Scanning of the Excitation Beam in the Two-Photon Microscope” (Kis-Petikova K. et al., Microscopy Research and Technique 63 (2004), 34-49) the method is extended to a distance measurement between two fluorophores with different emission spectra.

The dissertation “Trapping and Manipulating Single Molecules in Solution” (Adam E. Cohen, Dissertation, Stanford University, defended August 2006) describes how a fluorescent particle is tracked by using an orbiting focus as in orbital scanning, wherein the focus is deflected by means of acousto-optical deflectors. For this purpose, in an embodiment in which the detection rate of the fluorescence photons is less than the orbital frequency of the focus, a piezo displacement unit is moved essentially whenever a photon is detected during the orbit in such a way that the focus is moved radially outwards in the focal plane, wherein the path of the orbit is displaced relative to the particle in such a way that the particle is held in the center of the path. At detection rates greater than the orbital frequency, the displacement unit is moved after a full orbit in accordance with the photons detected during an orbit.

In the publication “Real-time nanomicroscopy via three-dimensional single-particle tracking” (Katayama Y. et al., Chemphyschem. 2009 Oct. 5; 10 (14): 2458-64. doi: 10.1002/cphc.200900436. PMID: 19760694; PMCID: PMC2857558.), an orbital tracking method is described in which an excitation focus is moved within a plane on a circular path, while the emission is detected in two planes that are slightly offset axially in opposite directions with respect to the confocal plane. It is also described that orbital tracking is performed while a wide-field image of the sample is simultaneously recorded using a different excitation wavelength. The orbital tracking is carried out using a piezo scanner.

In the publication “Nanoresolution real-time 3D orbital tracking for studying mitochondrial trafficking in vertebrate axons in vivo” (Wehnekamp, F. et al., (2019), eLife 8: e46059, https://doi.org/10.7554/eLife.46059), a combination of orbital tracking and wide field imaging is also described. Here, orbital tracking is performed using a photo activatable fluorescent dye, which enables tracking of individual organelles in a densely colored background.

The publication “Tracking-FCS: Fluorescence correlation spectroscopy of individual particles” (Berglund AJ and Mabuchi H, Optics Express 13, 20 (2005), 8069-8082) describes a fluorescence correlation spectroscopy method of individual dye molecules, in which a Gaussian excitation beam is displaced along a circular path, the molecule position is determined from demodulation of the fluorescence, and a drive signal is provided to a piezoelectric sample scanner to track the movement of the molecule.

The orbital method is usually described in connection with the use of a beam scanning device based in particular on galvo scanners. When using galvo scanners, a circular path is traced by controlling an x and a y deflection unit with the same frequency, whereby the course of the deflection over time follows a sine function. The radius of the path scales with the amplitude of the deflection, the center of the circular path corresponds to the mean value of the deflection.

In the international patent disclosure WO 2004/079405 A2, scanning methods are proposed, for example for confocal microscopy, which are intended to enable faster image acquisition using mechanical beam deflection devices. High accelerations of the mechanical beam deflection devices lead to stresses. In order to minimize these stresses when using the beam deflection device, the accelerations occurring during scanning should be minimized. For this purpose, the control of the deflection device with sinusoidal waveforms is optimal. Various control signals and corresponding scanning paths of a light beam are proposed. The control signals for an x-direction and a y-direction are sine and cosine signals respectively, which are varied slowly over time and at best are varied quickly at a single specific point in time during the traversing of an entire path. The resulting scan paths are different spiral paths or combinations of spiral paths.

The Japanese patent disclosures JP 2000-098238 A and JP 2005-241321 A also describe scanning methods in which image fields are scanned along spiral paths. The spiral paths are generated by controlling individual scanners with signals which correspond exactly or essentially to a product of a time-dependent sine or cosine function to a first frequency and a further sine or cosine function to a second frequency. In JP 2005-241321 A, such a drive signal is modified in such a way that the tangential velocity of the scanning movement remains constant during scanning. The scanning methods according to the two disclosure documents were marketed by Olympus under the name of Tornado Scanning as a scanning method exclusively for illumination, for example for FLIP, FRAP, photo activation, or photo conversion, uncaging, etc. The disclosure JP 2000-098238 A mentions that the individual deflection units of the scanner could also be controlled with a pure sine or cosine signal so that the scanning path corresponds to a Lissajous figure.

In the German patent specification DE 10 2016 117 096 B4, methods for imaging are specified, in particular by using STED microscopy, in which a particularly high resolution is achieved by scanning only a close range of the object to be imaged with an intensity profile, for example of the STED light with a central minimum, so that the object to be imaged is not exposed to the high intensities of the maxima limiting the minimum at any time during scanning and is therefore not bleached during scanning. Scanning with the intensity distribution can take place on a rectangular grid or the scanning takes place starting from the center of the object to be imaged on a spiral path.

The term “MINFLUX microscopy” or “MINFLUX method” refers to localization and tracking methods for singulated emitters in which light distributions of illumination light that excites light emissions from the emitter are generated at the focus in the sample, wherein the light distributions comprise a local minimum, and in which the position of a singulated emitter is determined by detecting light emissions of the emitter for different positions of the minima of the relevant light distributions or for different such light distributions in a close range of the emitter, in particular wherein the fact is used that the smaller the distance between the emitter and the minimum of the light distribution, the less light is emitted by the emitter. At the minimum itself, the emitter should be stimulated to emit as little as possible so that the increase in emission with increasing distance to the minimum of the light distribution is as large as possible in relation to the emission. Due to the latter fact, MINFLUX methods are particularly photon efficient, especially in comparison to localization methods based on the spatially resolved detection of the emission, such as those known from PALM or STORM microscopy, which means that a particularly high localization accuracy is achieved with MINFLUX methods for the same number of detected photons. This means that the emitters to be localized or tracked with the desired accuracy can be exposed to relatively little light compared to other localization methods and are therefore less bleached.

A method of the type described above is described in patent application DE 10 2011 055 367 A1 for single molecule tracking. According to the method disclosed there, the position of a single fluorophore is tracked over time by tracking an excitation light distribution with a local minimum to the fluorophore in such a way that the fluorescence emission rate is minimized.

The patent DE 10 2013 114 860 B3 describes in particular a localization method in which the sample is scanned at grid points with the local minimum of an excitation light distribution in order to localize individual fluorophores.

The term “MINFLUX” is introduced in the publication “Nanometer resolution imaging and tracking of fluorescent molecules with minimal photon fluxes” (Balzarotti F. et al., Science. 2017 Feb. 10; 355 (6325): 606-612 and in advance arXiv: 1611.03401 [physics.optics] (2016)). In the method described there, the MINFLUX principle is implemented in concrete terms by identifying small structures that have stochastically blinking fluorophores in a wide-field image and moving them as precisely as possible into the center of the wide-field image and then scanning the center area with a donut-shaped excitation light distribution in the center and at other points that form a symmetrical pattern of illumination positions around the center using electro-optical scanners. The positions of the individually blinking fluorophores of the structures are then determined to within a few nanometers from the photon counts registered for the individual illumination positions using a maximum likelihood estimator. For the same number of detected photons, the smaller the area delimited by scanning positions in which the fluorophore to be localized is located, the higher the accuracy. It is therefore advantageous to perform MINFLUX iteratively on individual fluorophores, wherein the defined area is reduced from step to step.

Another MINFLUX method is described in the international patent publication WO 2022/029283 A1. It uses an illumination pattern with six or more illumination positions that are rotationally symmetrical on a circle around a previously estimated position of an emitter. The illumination positions can be addressed step by step or in a continuous movement, wherein in the latter case, a section of the circular path can be treated collectively as a discrete scanning point. In one embodiment of this method, a background fluorescence is determined, which is taken into account when determining the position of the fluorophore from the measured values obtained at the positions of the illumination pattern.

In the European patent EP 3 372 990 B1, in addition to other MINFLUX methods, a method similar in one aspect to the MINFLUX method is described. As in a MINFLUX method, an isolated molecule is illuminated in a focused manner with an intensity distribution having a central minimum, preferably a zero, and increase regions surrounding it. As with MINFLUX, this minimum is placed at a number of scanning points around the presumed location of the singulated molecule and a fluorescence emission is detected for each scanning point; the actual position is estimated with high precision from the intensity values or photon counts obtained in this way. In contrast to MINFLUX, the intensity distribution is a distribution of fluorescence inhibition light, in particular STED light. It is used together with excitation light, wherein the intensity distribution of the excitation light does not have a central local minimum. While with MINFLUX the fluorescence emission is higher when the isolated molecule is further away from the central minimum of the intensity distribution, the opposite is true with this method.

In the publication “A common framework for single-molecule localization using sequential structured illumination” (Luciano A. Masullo et al.; Biophysical Reports, Volume 2, Issue 1, 2022, 100036; https://doi.org/10.1016/j.bpr.2021.100036.) it is shown that various methods for single-molecule localization can be understood as belonging to a common concept. In the publication, among other things, the method described in the above-mentioned disclosure WO 2022/029283 A1 using an excitation light distribution with a central minimum with illumination positions that are rotationally symmetrical on a circle around a previously estimated position is described as a new method and referred to as “Orbital Tracking with a MINimum” (OTMIN). Furthermore, a method for localization from a raster scan limited to a small area around the fluorophore to be localized using an intensity minimum for scanning, as already essentially described in patent DE 10 2013 114 860 B3, is presented and referred to as “RASTer scanning with a MINimum” (RASTMIN). These two methods are then used together with, among others, (classical) orbital tracking, localization from a confocal scan that is restricted to a small area around the fluorophore to be localized, and MINFLUX according to the version described in “Nano meter resolution imaging and tracking of fluorescent molecules with minimal photon fluxes” (Balzaroti, see above) with four scanning points, one of which corresponds to a central position, is subsumed under the term “single-molecule localization by sequential structured illumination” (SML-SSI). The achievable localization accuracies are investigated based on simulations. With reference to OTMIN, it is found that particles near the center can be localized very precisely, while particles near the circle can be determined much less accurately with the scanning positions. In this context, it is mentioned that the high uncertainty could be avoided experimentally by feeding information into the measurement to use a field of view that is restricted to the well-preserved, inner region, e.g. by periodically tracking the pattern in real time.

MINFLUX methods according to the prior art are characterized, as already explained, by a particularly high localization accuracy with high photon efficiency and high localization speed.

However, a disadvantage of existing MINFLUX methods is that relatively complex and expensive equipment is required, in particular scanning devices with electro-optical deflectors.

### Objective

It is now an objective of the present disclosure to achieve a high localization accuracy with simpler and more cost-effective technical means without major disadvantages in terms of measurement time.

### Solution

The objective is attained by the subject matter of the independent claims 1. Further embodiments of the method are given in the subclaims and are described below.

### DESCRIPTION

A first aspect of the present disclosure relates to a method for localizing or tracking an emitter in a sample, wherein the sample is illuminated with an intensity distribution of illumination light comprising a local intensity minimum, wherein the illumination light affects light emissions of the emitter, and wherein the intensity distribution is displaced on a path around a presumed position of the emitter, wherein light emissions, in particular individual light emissions, of the emitter are detected in a time-resolved manner in a measurement time interval to obtain an emission signal, and wherein a position of the emitter in the sample is estimated based on a temporal modulation of the emission signal caused by the displacement of the intensity distribution on the path.

In this application, emitters are understood to be objects which, when illuminated with excitation light, can be regarded as point light sources with regard to the measurements according to the disclosure. The light emitted by the object that acts as a point light source may, for example, be scattered light resulting from elastic scattering such as Rayleigh scattering or inelastic scattering such as Raman scattering or it may be luminescent light, in particular fluorescent light.

In this application, the term localization describes a method in which the position of an individual emitter in a sample is determined. In contrast to conventional light microscopic methods, no optical imaging of the sample is required. Rather, the method according to the disclosure uses a position estimator to calculate the estimated position of an emitter based on its light emissions. This method may be carried out successively for several individual emitters which are singulated, i.e. have a distance above the microscopic diffraction limit or can be separated by measurement in another way (e.g. via different emission spectra), and the determined positions may be displayed in a localization map which may produce a high-resolution light microscopic image. Under certain conditions, several emitters with a distance below the diffraction limit may also be localized simultaneously or in parallel.

The tracking of an emitter is understood to be the consecutive, multiple localization of an emitter moving in the sample. The corresponding positions may then be displayed as a trajectory, for example.

The intensity distribution of the illumination light comprises a local intensity minimum, in particular an intensity zero. In particular, this minimum is located centrally, i.e. at the geometric focus. In particular, the intensity distribution may be symmetrical (especially in the lateral direction, i.e. in a focal plane extending perpendicular to the optical axis, and optionally also in the axial direction, i.e. along the optical axis). The intensity distribution may, for example, be a so-called donut or a so-called bottle beam. Such distributions may be generated in particular by phase modulation of the light beam with a phase pattern (a vortex phase pattern for a donut and a ring-shaped phase jump for a bottle beam), wherein the intensity distribution is formed at the focus by interference. Phase modulation may be performed, for example, with a phase filter or a controllable spatial light modulator in the excitation beam path. In particular, such a phase filter or light modulator may be arranged in a pupil plane conjugate to the back aperture of the objective. For certain phase patterns, such as a vortex phase pattern, it may also be necessary or advantageous to circularly polarize the light beam.

In particular, the method according to the disclosure may be a MINFLUX method or a STED-MINFLUX method. In the case of a MINFLUX method, the illumination light which affects the light emissions of the emitter is excitation light. In this case, the emitters may in particular be luminophores, further in particular fluorophores, or molecules or particles labeled with one or more luminophores, wherein the excitation light converts the emitters into an excited state from which the emitter falls back into a ground state by emitting a photon. Alternatively, the emitters may also be particles that reflect or scatter the excitation light. In so-called STED-MINFLUX methods, an intensity distribution of excitation light comprising a local maximum is superimposed with an intensity distribution of inhibition light (in particular STED light) with a local minimum at the focus in the sample. In this case, the illumination light affecting the light emissions of the emitter is inhibition light.

In MINFLUX methods and STED-MINFLUX methods according to the prior art, the local minimum of the intensity distribution of the illumination light is shifted successively to several positions in the sample in a close range of a presumed position of an individual emitter, usually with electro-optical deflectors. A plurality of light emissions are recorded for each position. An estimated position of the emitter may then be determined from the emission rates (photons per time unit) at the various positions using a position estimator. With MINFLUX methods, the closer the minimum of the intensity distribution is to the actual position of the emitter, the lower the photon emission rate-if the emitter is exactly at the minimum, no light is emitted at all (apart from background).

For this reason, MINFLUX methods are particularly photon-efficient, i.e. an emitter can be localized with particularly high precision with a given number of photons or with particularly few photons for a given accuracy. With STED-MINFLUX methods, on the other hand, the smaller the distance between the minimum of the intensity distribution of the illumination light (in this case inhibition light, e.g. STED light) and the actual position of the emitter, the higher the photon emission rate.

One of the advantages of the method according to the disclosure over MINFLUX methods according to the prior art is that a high localization accuracy at a high scanning speed can also be achieved with considerably simpler and less expensive scanning devices, in particular without electro-optical deflectors (EOD). This is achieved by moving the intensity distribution along a path, particularly a continuous path, around the emitter instead of controlling defined scanning positions in the sample. Such a path, which in the case of a two-dimensional movement in the focal plane can be circular or elliptical, for example, or have the shape of a hypotrochoid or Lissajous figure (see below), can also be realized with good accuracy and high speed using a galvo scanner, which is much simpler and cheaper than EODs.

The path may be two-dimensional and, for example, run in the focal plane (perpendicular to an optical axis of the objective) or the path may run three-dimensionally around the presumed position of the emitter.

According to the present disclosure, the intensity distribution of the illumination light (i.e. its intensity minimum) is displaced on a path around a presumed position of the emitter. In the context of the present specification, this means that the path comprises locations which, with respect to at least one spatial coordinate, lie on opposite sides of the presumed position of the emitter. The path may enclose the presumed position of the emitter (as, for example, in the case of a circle whose center is the presumed position of the emitter), but it may also intersect the presumed position of the emitter (e.g. in the case of a rosette-shaped path or a Lissajous figure).

In MINFLUX methods according to the prior art, the intensity distribution of the illumination light is shifted abruptly between scanning positions (e.g. with EODs). Light emissions are recorded for each scanning position in a predefined measurement period. A photon rate is then determined from the quotient of the measured photon number and the length of the measurement period, which is assigned to the respective defined scanning position.

This type of evaluation is not possible with the method according to the present disclosure-here the intensity distribution is moved continuously along the path, wherein the light emissions are distributed randomly. There are therefore no defined scanning positions and no predefined measurement period.

According to the present disclosure, this problem is solved by detecting light emissions from the emitter in a time-resolved manner in a measurement time interval to obtain an emission signal. In particular, the light emissions may be individual photons detected and registered by a detection device. Alternatively, a light emission may also be a detection event in which several photons are detected simultaneously or in quick succession.

According to one embodiment, the emission signal may, for example, be represented as a vector, wherein the elements of the vector each represent a subsection of the measurement time interval (in particular subsections of equal length), and wherein a respective element has a value which corresponds to the number of photons registered in the subsection. The number of registered photons per subsection may in particular be a number between 0 and 10, further in particular a number between 0 and 5, still further in particular a number between 0 and 2. If the subsections of the measurement time interval are selected in such a way that only a maximum of one photon is registered in each subsection, the vector may also have only binary values (0 or 1).

Surprisingly, in the course of the present disclosure, it has been found that it is possible to reliably estimate the position of the emitter by analyzing the temporal modulation of such a signal from light emissions, for example by Fourier analysis or phasor analysis (as described in more detail below).

According to the prior art for orbital tracking with a Gaussian light distribution, an analysis of the signal modulation has so far only been described for high photon counting rates at which a quasi-analog signal is present. In contrast, for lower counting rates, the prior art teaches to react to individual photons with a deflection of the light distribution. However, such a reaction to individual photons is not suitable for many applications of MINFLUX microscopy due to the high susceptibility to background.

On the other hand, however, the MINFLUX technique is characterized by particularly low photon counting rates, especially in the localization steps where the minimum of the intensity distribution is already relatively close to the actual position of the emitter.

The realization that the position of a single emitter can be estimated with high accuracy by evaluating the temporal modulation of an emission signal consisting of time-resolved emission events is therefore particularly valuable for MINFLUX microscopy.

The measurement time interval may, for example, comprise one or more orbits of the intensity distribution around the presumed position of the emitter.

The light emissions may be detected, for example, with a detector sensitive to individual photons (e.g. an avalanche photodiode, APD), which is coupled with suitable measurement electronics for time-resolved registration. For example, an arrival time of the individual photons relative to an excitation pulse may be determined or the individual photons may be assigned time stamps relative to an electronic control pulse. The latter is of course possible not only with pulsed but also with continuous irradiation of the sample with the illumination light). Time-resolved detection may also be carried out with a gating-capable detector (e.g. by means of electronic gating).

According to the present disclosure, the measurement time interval has to be related in time to the path of the intensity distribution. The phase shift between the time series of the light emissions and the time series of the positions of the intensity distribution must therefore be determined (at least implicitly). This can be done, for example, by coordinating the timing of the control electronics of a beam scanner (e.g. galvo scanner) with the measurement electronics of the detector.

The emission signal is evaluated using a computing unit that is coupled to or integrated into the light microscope according to the present disclosure. In particular, the computing unit may be a field programmable gate array (FPGA), an application specific integrated circuit (ASIC), a microprocessor or a general-purpose computer.

The emission signal may be evaluated during a measurement, i.e. parallel to the illumination of the sample with the illumination light, or also after a measurement.

According to one embodiment, the intensity distribution is displaced relative to the sample by means of a mechanical scanner, in particular wherein the intensity distribution may be displaced continuously. In contrast to, for example, electro-optical or acousto-optical scanners, mechanical scanners have movable components which, for example, deflect a light beam or displace a sample holder relative to a light beam. The mechanical scanner may be, for example, a galvanometer scanner, a resonant scanner or a piezoelectric scanner. In particular, the mechanical scanner may be a beam scanner that displaces a beam of illumination light.

Galvanometer scanners, for example, are suitable for this purpose. Alternatively, the mechanical scanner may also be coupled to a sample stage, for example, so that the sample is displaced by the scanner relative to a stationary light beam. Piezo scanners, for example, are well suited for the latter embodiment.

Mechanical scanners may be operated resonantly or non-resonantly. Resonant mechanical scanners have certain desired natural frequencies at which they are operated. Non-resonant mechanical scanners include galvanometer scanners, in which a galvanometer drive is typically coupled to a mirror so that a current signal fed into the galvanometer coils may be used to adjust the angle of the mirror around the axis of rotation. In galvanometer scanners, the axes of rotation of the mirrors are typically not parallel to the optical axis of the incident light beam. At least one movable mirror coupled to a galvanometer drive is provided for each spatial direction in which the beam is to be deflected. Mechanical scanners with so-called Risley prism pairs are also known, wherein the illuminating light beam passes successively through two wedge-shaped prisms that rotate around parallel axes of rotation.

Mechanical scanners are typically less expensive, simpler in design and more robust than, for example, electro-optical scanners (which are used, for example, in MINFLUX microscopes according to the prior art) or acousto-optical scanners. Mechanical scanners can advantageously be controlled quickly and precisely to displace the intensity distribution of the illumination light on the path. Thus, mechanical scanners in combination with the position determination method according to the present disclosure enable a particularly simple, robust and cost-effective implementation of a MINFLUX method.

Alternatively, the method according to the present disclosure with the advantages described above may of course also be carried out with electro-optical or acousto-optical scanners.

According to a further embodiment, at least one spatial coordinate of the emitter is estimated by means of Fourier analysis of the emission signal. For example, the emission signal can be broken down into components of a Fourier series using a Fast Fourier Transform (FFT) algorithm. A position estimator for the position of the emitter with respect to the at least one spatial coordinate may then be derived from the Fourier coefficients determined during the Fourier analysis and the position may be determined using the derived position estimator. The Fourier analysis may be carried out in particular based on a circular frequency of the movement of the intensity distribution on the path, since the emission signal is modulated with this circular frequency if the presumed position of the emitter does not correspond to its actual position. The latter is of course also possible if the movement of the intensity distribution is not circular, particularly also if the movement is characterized by several different circular frequencies (as is the case with certain hypotrochoids or Lissajous figures, for example). The Fourier analysis may be carried out discretely or continuously in time.

According to a further embodiment, estimated values for a first spatial coordinate and a second spatial coordinate of the emitter are determined from the emission signal based on the formulae \hat{x}=∫₀^{N·2π/ω} E(t)·cos(k·ω t) dt and ŷ=∫₀^{N·2π/ω} E(t)·sin(k·ω t) dt, wherein E(t) denotes the emission signal, t denotes the time, w denotes a circular frequency of the movement of the intensity distribution on the path, and N and k are natural numbers, wherein a local intensity profile, in particular a previously known local intensity profile, of the intensity distribution is used as a basis for determining the first spatial coordinate and the second spatial coordinate. In particular k=1 (i.e. the first coefficients of the Fourier series are determined in each case). \hat{x} and ŷ are Fourier coefficients. In particular, the estimated values for the first spatial coordinate and the second spatial coordinate are obtained by equating a value obtained by numerical integration of the product of the emission signal with a cosine or sine function (which has the circular frequency as an argument) to an analytically determined Fourier coefficient which is a function of the corresponding first or second spatial coordinate. The corresponding estimated value can then be obtained by solving the equation for the first or second spatial coordinate. In particular, a system of equations obtained from the values obtained by numerical integration and the analytically determined Fourier coefficients may be solved to obtain the estimated values. The first spatial coordinate and the second spatial coordinate may be Cartesian coordinates. For example, the first spatial coordinate and the second spatial coordinate may describe the position of the emitter in a focal plane in the sample which is perpendicular to an optical axis along which an illumination light beam illuminates the sample with the illumination light. In this case, the first spatial coordinate may also be referred to as the x-coordinate and the second spatial coordinate as the y-coordinate. Alternatively or additionally, a spatial coordinate (also referred to as z-coordinate) may describe the position of the emitter in an axial direction parallel to the optical axis, e.g. for a localization of the emitter in three dimensions or for a localization in an xz-plane or yz-plane. Of course, the first spatial coordinate and the second spatial coordinate are not limited to Cartesian coordinates. The spatial coordinates may also be polar coordinates or cylindrical coordinates, for example.

According to a further embodiment, the emission signal is represented by the formula E(t)=a·[(x−Iₓ(t))^{c}+(y−I_{y}(t))^{c}] or E(t)=a·[(x−Iₓ(t))^{c}+ (y−I_{y}(t))^{c}]+b wherein x is the first spatial coordinate of an actual position of the emitter, wherein y is the second spatial coordinate of the actual position of the emitter, wherein Iₓ(t) describes a temporal change of the first spatial coordinate caused by the movement of the intensity distribution on the path, wherein I_{y}(t) describes a temporal change of the second spatial coordinate caused by the movement of the intensity distribution on the path, wherein a describes a first shape parameter of the intensity distribution, and wherein c describes a second shape parameter of the intensity distribution. In particular b describes a parameter representing the background. In particular, the second shape parameter is an even number (c=2n, wherein n is a natural number). In particular, the second shape parameter is equal to 2 (c=2).

In this case, the course of the intensity distribution is approximated by a parabola or a higher polynomial (in particular with c=2n as the curve is then symmetrical to the intensity minimum). For example, a donut-shaped intensity distribution can be approximated to a good approximation as a parabola in the vicinity of the central minimum. In case c=2, the first shape parameter a is a measure of the steepness of the parabolic intensity distribution.

The parameter b representing the background indicates the light intensity for the conditions (x=Iₓ, y=I_{y}), i.e. when the position of the minimum of the intensity distribution coincides with the actual location of the emitter. The measured light emissions then (at least if the minimum is a true intensity zero even under experimental conditions) do not originate from the emitter to be localized or tracked but are due to background.

In the context of the present specification, the term “background” refers to any light registered by the detector that does not originate from the currently localized or tracked emitter. This includes both background light, which can originate in particular from emitters located axially above or below the focal plane, as well as, for example, so-called dark counts, i.e. incorrectly registered photons due to detector noise or similar effects.

The parameter b may also be zero. This can be particularly useful in cases where the background does not contribute significantly to the emission signal to estimate the position of the emitter with high accuracy. If the background is taken into account by means of the parameter b, b may be assumed to be constant in time and location, for example. Alternatively, the value b may also be based on a local distribution of the background relative to the minimum of the intensity distribution of the illumination light.

According to a further embodiment, the temporal change of the first spatial coordinate and the temporal change of the second spatial coordinate are each represented by a sine function or cosine function.

A circular path of the intensity distribution around the presumed position of the emitter with the radius L/2 can be described using the formulas Iₓ(t)=L/2·sin(ωt) and I_{y}(t)=L/2·cos(ωt). The formulas Iₓ(t)=L₁/2·sin(ωt) and I_{y}(t)=L₂/2·cos(ωt) with different amplitudes L₁/2≠L₂/2 describe an elliptical path. The embodiment described above also includes, for example, Lissajous figures, which are described by the equations Iₓ(t)=L₁/2·sin(ω₁t) and I_{y}(t)=L₂/2·sin(ω₂t) or I_{y}(t)=L₂/2·cos(ω₂t) where ω₁ and ω₂ are different circular frequencies which are in a fixed ratio to each other (equal to a rational number not equal to 1).

According to a further embodiment, the temporal change of the first spatial coordinate and the temporal change of the second spatial coordinate are each represented by a weighted sum of sine functions and/or cosine functions with a finite number of summands. This means that the change in each spatial coordinate is described by at least two sine and/or cosine functions. The terms sine function and cosine function are redundant in that each sine function can be expressed as a cosine function by a phase shift of 90°. In particular, the temporal change of the first spatial coordinate and the temporal change of the second spatial coordinate are each represented by a weighted sum of 10 sine functions and/or cosine functions or less, further in particular four sine functions and/or cosine functions or less, further in particular two sine functions and/or cosine functions.

Both paths in which the temporal changes in the spatial coordinates can be expressed as sine functions or cosine functions and paths in which the temporal changes in the position coordinates can be expressed as weighted sums of sine functions or cosine functions have the advantage that mechanical scanners in particular, such as galvanometer scanners, can realize such paths with particularly good accuracy even at high scanning speeds (i.e. with a particularly low deviation between the desired path and the path actually traveled) if they are controlled with corresponding control signals. The bandwidth of such scanners can be utilized particularly well with these control signals.

According to a further embodiment, the sine functions and/or the cosine functions have different circular frequencies, which are in a fixed ratio to each other. Advantageously, additional information can be obtained from the different circular frequencies when evaluating the emission signal, which can be used, for example, to determine a shape parameter of the intensity distribution or to estimate background.

For example, the first spatial coordinate may be described by the equation Iₓ(t)=L_{1,x}/2·cos(ω₁t)−L_{2,x}/2·cos(ω₂t) and the second spatial coordinate by the equation I_{y}(t)=L_{1,y}/2·sin(ω₁t)−L_{2,y}/2·sin(ω₂t). The corresponding path is an epitrochoid.

Alternatively, the first spatial coordinate may also be described by the equation Iₓ(t)=L_{1,x}/2·cos(ω₁t)+L_{2,x}/2·cos(ω₂t) and the second spatial coordinate by the equation I_{y}(t)=L_{1,y}/2·sin(ω₁t)−L_{2,y}/2·sin(ω₂t) or I_{y}(t)=L_{1,y}/2·sin(ω₁t)+L_{2,y}/2·sin(ω₂t). The corresponding path is a hypotrochoid.

Curves of the form Iₓ(t)=L_{1,x}/2·cos(ω₁t)+L_{2,x}/2·cos(ω₂t); I_{y}(t)=L_{1,y}/2·sin(ω₁t)−L_{2y}/2·sin(ω₂t)) are also referred to as rosettes.

Curves of the form Iₓ(t)=L_{1,x}/2·cos(ω₁t)+L_{2,x}/2·cos(ω₂t) and I_{y}(t)=L_{1,y}/2·sin(ω₁t)+L_{2,y}/2·sin(ω₂t) are referred to as loops in the context of this specification. This includes, for example, the so-called Pascal's snails. For rosettes and loops, the conditions L_{1,x}/2=L_{1,y}/2 and L_{2,x}/2=L_{2,y}/2 may in particular also apply additionally.

According to a further embodiment, the path may be described by a superposition of different circular frequencies, wherein additional information is obtained by means of an evaluation of the emission signal, wherein the additional information is used to determine estimated values for further parameters, e.g. a shape parameter of the intensity distribution and/or a parameter representing the background, in addition to the position of the emitter. This is possible, for example, with paths that can be mathematically described as Lissajous figures or hypotrochoids, in particular rosettes or loops. In particular, such paths have the advantage that they are closed and, in particular, symmetrically arranged around a center at which, for example, the presumed position of the emitter can be located.

According to a further embodiment, the estimated values for the further parameters comprise an estimated value for a shape parameter of the intensity distribution and/or an estimated value for background.

According to a further embodiment, integrals or sums are calculated over the emission signal over different integration limits or summation limits to determine the estimated values for the further parameters. It may be necessary to ensure that the integrals over the different integration limits result in linearly independent equations for the corresponding parameters, so that the parameters can be determined by solving a system of equations. In particular, an integral may be calculated over an analytical expression for the emission signal, wherein the analytical expression is formed based on a temporal progression of the light emissions dependent on the actual emitter position and based on an assumed local progression of the intensity distribution of the illumination light. Such an analytical expression for the assumption of a parabolic intensity distribution may be, for example, E(t)=a·[(x−Iₓ(t))²+(y−I_{y}(t))²] or E(t)=a·[(x−Iₓ(t))²+(y−I_{y}(t))²]+b (if background is taken into account), wherein Iₓ(t) describes a temporal change of the first spatial coordinate caused by the movement of the intensity distribution on the path, where I_{y}(t) describes a temporal change of the second spatial coordinate caused by the movement of the intensity distribution on the path, and wherein a describes a first shape parameter of the intensity distribution. In particular, b describes a parameter representing the background. This integral may then be compared, for example, with a numerically formed sum over the registered light emissions in order to obtain a further equation in addition to the equations determined from the Fourier coefficients, wherein a further parameter, in particular the shape parameter or the parameter representing the background, is estimated by solving the corresponding system of equations in addition to the estimate of the spatial coordinates.

According to a further embodiment, in particular in addition to the estimated values for the first spatial coordinate and the second spatial coordinate, an estimated value for a further parameter, in particular a shape parameter of the intensity distribution and/or a parameter representing a background, is determined based on the formula \hat{n}ᵢ=∫_{M·2π/ω}^{N·2π/ω} E(t) dt and based on the formulae \hat{x}=∫₀^{N·2π/ω} E(t)·cos(k·ω t) dt and ŷ=∫₀^{N·2π/ω} E(t)·sin(k·ω t) dt, wherein M is zero or a natural number less than N.

According to a further embodiment, estimated values for further parameters, in particular a shape parameter of the intensity distribution and a parameter representing a background, are determined based on the formula \hat{n}₁=∫₀^{M}^{₁}^{·2π/ω} E(t) dt and the formula \hat{n}₂=∫_{M}_{₁}_{·2π/ω}^{M}^{₂}^{·2π/ω} E(t) dt or from the formula \hat{n}₁=∫_{M}_{₁}_{·2π/ω}^{M}^{₂}^{·2π/ω} E(t) dt and \hat{n}₂=∫_{M}_{₂}_{·2π/ω}^{N}^{₂}^{·2π/ω} E(t) dt and based on the formulae \hat{x}=∫₀^{N·2π/ω} E(t)·cos(k·ω t) dt, and ŷ=∫₀^{N·2π/ω} E(t)·sin(k·ω t) dt, wherein M₁ and M₂ are natural numbers smaller than N and where M₁ is smaller than M₂.

The parameters \hat{n}ᵢ, \hat{n}₁ and \hat{n}₂ describe sums of light emissions in the time intervals of the integration limits. By summing up the light emissions registered in the corresponding time interval and equating the sum to the analytically calculated integral (using a known intensity curve of the illumination light and the path of the intensity distribution around the presumed position of the emitter), a further equation can be obtained in addition to the equations obtained by determining the Fourier coefficients x and y. By solving the corresponding system of equations, a further parameter can be estimated in addition to the first spatial coordinate and the second spatial coordinate, e.g. a shape parameter of the intensity distribution curve (such as the slope of a parabola) or a parameter representing the background. It is important to ensure that the integration limits M₁ and M₂ for the respective path used are selected in such a way that linearly independent expressions from \hat{n}₁ and \hat{n}₂ (and further \hat{n}ᵢ) can be formed so that the resulting system of equations can be solved unambiguously for the desired number of parameters.

In this way, a highly accurate position estimate can be made even if the shape parameter of the intensity distribution and/or the background is unknown.

According to a further embodiment, an angular coordinate of the emitter is estimated by means of phasor analysis of the emission signal, wherein the estimation of the angular coordinate is based on a local intensity curve of the intensity distribution.

Advantageously, using phasor analysis, an angular coordinate of the emitter in the focal plane can be estimated in a simple manner. This can be used to derive the direction in which the intensity distribution must be shifted in an iterative MINFLUX method to bring the center of the path closer to the actual position of the emitter.

According to a further embodiment, the angular coordinate is determined based on the formula. φ=tan⁻¹ŷ/\hat{x} wherein \hat{x}=∫₀^{N·2π/ω} E(t)·cos(k·ω t) dt and ŷ=∫₀^{N·2π/ω} E(t)·sin(k·ω t) dt, wherein E(t) denotes the emission signal, t denotes the time, ω denotes a circular frequency of the movement of the intensity distribution on the path, and N and k are natural numbers.

Fourier coefficients are therefore determined from the emission signal as described above. From the arc tangent function of the quotient of the Fourier coefficients ŷ and \hat{x} the phase angle φ (the angular coordinate of the position of the emitter) can then be derived. One advantage here is that, particularly when using a parabolic approximation or a symmetrical polynomial approximation for the intensity distribution, the shape parameter a described above may be canceled out, as it is multiplicatively included in both Fourier coefficients, at least if the background is not taken into account. Therefore, if the background is negligible, the phase angle obtained is independent of the shape of the intensity distribution used.

According to a further embodiment, a radial coordinate of the emitter is also estimated using the phasor analysis. Thus, for example, both polar coordinates of the emitter in the focal plane can be determined.

According to a further embodiment, the radial coordinate is determined based on the formula

$$ρ = \frac{\sqrt{{\hat{x}}^{2} + {\hat{y}}^{2}}}{\hat{n}} , wherein \hat{x} = {\int }_{0}^{N \cdot 2 π / ω} E ( t ) \cdot cos ( k \cdot ω t ) dt , \hat{y} = {\int }_{0}^{N \cdot 2 π / ω} E ( t ) \cdot sin ( k \cdot ω t ) dt and \hat{n} = {\int }_{0}^{N \cdot 2 π / ω} E ( t ) dt .$$

To determine the radial coordinate, the sum n of the light of the light emissions may be determined, in particular during one or more complete orbits of the intensity distribution around the presumed position of the emitter.

According to a further embodiment, a radius of a circular path of the intensity distribution around the presumed position of the emitter is adapted during the measurement time interval or between measurement time intervals, wherein a plurality of emission signals are determined from respective light emissions that are assigned to different radii of the path, wherein the position of the emitter is estimated based on temporal modulations of the plurality of emission signals, in particular by Fourier analysis or phasor analysis. The radius of the circular path may be changed on a time scale that is fast compared to the circular motion, so that the radius changes abruptly. Depending on the design of the scanner, this results in a relaxation time of different lengths, after which the intensity distribution of the illumination light follows the locus curve specified by the control parameters with sufficient accuracy. If the deviation from the predetermined locus curve during the relaxation time is so large that the accuracy of the position estimate deteriorates, it may be advantageous not to take the light emissions registered during the relaxation time into account in the position estimate. As an alternative to a sudden change in the radius, it is also possible for the radius of the circular path to be changed on a time scale that lies in the range of the speed of the circular movement. This results in particular in a spiral-shaped path which, after a certain time, leads to a circular path with the new radius. If the spiral path resulting from a control is known and reproducible, any light emissions detected on the spiral path may also be taken into account for the evaluation.

In particular, the radius may also be adjusted to a value of 0, i.e. a first emission signal obtained by moving the intensity distribution along a path, in particular a circular path, may be evaluated together with a second emission signal, the second emission signal comprising light emissions that are registered while the intensity minimum of the intensity distribution of the illuminating light remains stationary at the presumed position of the emitter.

According to a further embodiment, the intensity distribution is displaced on a non-circular path around the presumed position of the emitter, wherein the path comprises subsections which lie approximately on circles with different radii around the presumed position of the emitter, wherein a plurality of emission signals are determined from the light emissions assigned to the respective subsections, and wherein the position of the emitter is estimated based on temporal modulations of the plurality of emission signals, in particular by Fourier analysis or phasor analysis. Such a non-circular path may be, for example, a Lissajous figure or a hypertrochoid (e.g. a rosette or loop).

The plurality of emission signals obtained by adjusting the radius of the circle or assigning them to sections of the path advantageously generate additional independent data sets based on which the position of the emitter can be estimated more accurately and/or based on which further parameters, e.g. a shape parameter of the intensity distribution and/or a parameter representing the background, may be estimated.

According to a further embodiment, an estimated value for a shape parameter of the intensity distribution and/or an estimated value for background is additionally determined based on the multiple emission signals.

According to a further embodiment, estimated values for a first spatial coordinate of the emitter and a second spatial coordinate of the emitter and an estimated value for a further parameter, in particular a shape parameter of the intensity distribution and/or a parameter representing a background, are determined based on the formulae \hat{x}=∫₀^{N·2π/ω} E_{L1}(t)·cos(k·ω t) dt+∫₀^{N·2π/ω} E_{L2}(t)·cos(k·ω t) dt, ŷ=∫₀^{N·2π/ω} E_{L1}(t)·cos(k·ω t) dt+∫₀^{N·2π/ω} E_{L2}(t)·sin(k·ω t), \hat{n}₁=∫₀^{N·2π/ω} E_{L1}(t) dt and \hat{n}₂=∫₀^{N·2π/ω} E_{L2}(t) dt, in particular wherein the estimation may be based on a local intensity profile of the intensity distribution or intensity distributions, and wherein E_{L1}(t) and E_{L2}(t) denote emission signals assigned to the different radii, t denotes the time, w denotes a circular frequency of the movement of the intensity distribution on the path, and N and k are natural numbers. As described above, the emission signals assigned to different radii may be obtained, for example, from circular movements of the intensity distribution with different radii or by non-circular paths whose subsections lie approximately on circles with different radii around the presumed position of the emitter. Since the emission signals assigned to different radii are typically registered one after the other, separate integration of the emission signals (as described above) may be carried out in particular. Alternatively, if the integration limits are suitable, an integration over the sum E_{L1}(t)+E_{L2}(t) could also be carried out. Numerical values for \hat{x} and ŷ may be obtained in particular from a Fourier transformation of a sum signal, wherein the sum signal corresponds to the sum of the emission signals. Of course, the position estimate may also be based on one of the individual signals, but the use of a sum signal may be advantageous, particularly with low emission rates, as in this case more photons are included in the position estimate.

In this way, for example, equations dependent on both radii L1 and L2 may be derived for the first spatial coordinate, the second spatial coordinate and an equation dependent on L1 and L2 for a further parameter, in particular a shape parameter and/or a parameter for background. The corresponding system of equations may then be solved for the first spatial coordinate, the second spatial coordinate and the further parameter(s).

According to a further embodiment, a power of the illumination light is varied, in particular during the displacement of the intensity distribution around the presumed position of the emitter, wherein a plurality of emission signals are determined from light emissions obtained at the same power in each case, and wherein the position of the emitter is estimated based on temporal modulations of the plurality of emission signals, in particular by Fourier analysis or phasor analysis.

This is another way of obtaining independent data sets to make a more accurate position estimate or determine further parameters.

According to a further embodiment, an estimated value for further parameters, in particular a shape parameter of the intensity distribution and/or a parameter for background, is also determined based on the plurality of emission signals.

According to a further embodiment, estimated values for a first spatial coordinate of the emitter and a second spatial coordinate of the emitter as well as an estimated value for a further parameter, in particular a shape parameter of the intensity distribution and/or a parameter for background, are determined based on the formulae \hat{x}=∫₀^{N·2π/ω} Eₐ₁(t)·cos(k·ω t) dt+∫₀^{N·2π/ω} Eₐ₂(t)·cos(k·ω t) dt, ŷ=∫₀^{N·2π/ω} Eₐ₁(t)·sin(k·ω t) dt+∫₀^{N·2π/ω} Eₐ₂(t)·sin(k·ω t) dt, \hat{n}₁=∫₀^{N·2π/ω} Eₐ₁(t) dt and \hat{n}₂=∫₀^{N·2π/ω} Eₐ₂(t) dt, wherein in particular the estimation may be based on a local intensity profile of the intensity distribution or intensity distributions, and wherein Eₐ₁(t) and Eₐ₂(t) denote emission signals assigned to the different powers of the illumination light, t denotes the time, ω denotes a circular frequency of the movement of the intensity distribution on the path, and N and k are natural numbers. Here too, the integration may be carried out separately over both emission signals (as described above), since the signals are typically recorded one after the other. Alternatively, if the integration limits are suitable, integration over the sum Eₐ₁(t)+Eₐ₂(t) is also possible.

Numerical values for \hat{x} and ŷ may be obtained in particular from a Fourier transformation of a sum signal, wherein the sum signal corresponds to the sum of the emission signals. The individual signals may also be used here as an alternative. However, the use of the sum signal may have an advantageous effect on the accuracy of the position estimate due to the higher number of photons.

According to a further embodiment, after the position has been estimated, a renewed position determination of the emitter is carried out, wherein the intensity distribution of the illumination light is displaced on a path around the previously estimated position of the emitter during the renewed position determination, wherein further light emissions of the emitter are detected in a time-resolved manner in a further measurement time interval, and wherein a further emission signal is obtained from the light emissions detected in the further measurement time interval, and wherein the position of the emitter is estimated again based on a temporal modulation of the further emission signal caused by the displacement of the intensity distribution on the path around the previously estimated position, in particular with increased accuracy. In other words, the procedure is carried out iteratively. This allows the position to be determined with particularly high accuracy. In addition, an iterative method means that the position estimate is largely free of any systematic errors that can occur with larger distances between the presumed position and the actual position of the emitter, as this distance is successively reduced in the iteration steps.

According to a further embodiment, at least one parameter of the intensity distribution and/or at least one parameter of the path is adjusted for the renewed position determination. In particular, an area traversed by the path may be reduced by the estimated position of the emitter and/or a power of the illumination light may be increased. This means, for example, that a radius of a circular path may be changed, in particular reduced, based on an actual emitter position known from the previous iteration step with better accuracy than at the beginning or, in the case of a non-circular path, such as a Lissajous figure or a hypotrochoid, the amplitudes assigned to the various circular frequencies may be changed, in particular reduced. Since in this case fewer light emissions from the emitter are to be expected in the following iteration, as the minimum of the intensity distribution on its path is on average closer to the actual position of the emitter, it may be advantageous to increase the overall intensity of the illumination light to obtain a sufficient signal.

A second aspect of the present disclosure relates to a light microscope for localizing or tracking an emitter in a sample, in particular for carrying out a method according to the first aspect, comprising illumination optics which are configured to illuminate the sample with an intensity distribution of illumination light comprising a local intensity minimum, wherein the illumination light affects light emissions of the emitter, a scanner which is configured to displace the intensity distribution on a path around a presumed position of the emitter, a detection device which is configured to detect light emissions, in particular individual light emissions, of the emitter in a time-resolved manner in a measurement time interval to obtain an emission signal, and a computing unit which is configured to estimate a position of the emitter in the sample based on a temporal modulation of the emission signal caused by the displacement of the intensity distribution on the path.

In particular, the illumination optics comprise a light source, e.g. a laser, which is configured to generate an illumination light beam, a light modulator (e.g. a phase plate or a controllable spatial light modulator) which is configured to modulate the phase and/or amplitude of the illumination light beam to form the intensity distribution with the local intensity minimum at the focus in the sample, and an objective which is configured to focus the illumination light beam into the sample.

The scanner may consist of one scanning device or several scanning devices. Furthermore, the scanner may be a beam scanner, which moves the illumination light beam relative to the sample, or a sample scanner, which moves the sample relative to the illumination light beam. Suitable beam scanners are, for example, mechanical scanners with movable mirrors (e.g. galvanometer scanners), electro-optical scanners (EODs) or a combination of a mechanical scanner and an electro-optical scanner. A sample scanner may, for example, be a piezo scanner coupled with a sample holder.

The detection device is a detector that is suitable for the time-resolved detection and registration of light emissions (photons). An avalanche photodiode (APD), for example, is suitable for this purpose and can optionally be coupled with evaluation electronics for single photon registration. If the detection device is configured as a point detector, it is advantageous to arrange a pinhole in front of the detection device to block background from planes above and below the focal plane. In this case, the light emissions from the sample are therefore detected confocally. Alternatively, it is also possible, for example, to use a two-dimensional arrangement of detector elements (so-called array detector) as the detection device, which are arranged in a detection plane and thus detect the light from the sample in a spatially resolved manner. In this case, it may be advantageous if the individual detector elements are suitable for the time-resolved detection and registration of photons. This is the case with APD arrays, for example.

As already mentioned, the computing unit may be a field programmable gate array (FPGA), an application specific integrated circuit (ASIC), a microprocessor or a general purpose computer. The computing unit may be configured to perform the position estimation “live”, i.e. in parallel with the displacement of the intensity distribution and detection of the light emissions. Alternatively, only emission signals may be stored in parallel with the displacement of the intensity distribution and detection of the light emissions, with the position estimate being carried out at a later time based on the stored data. In the latter case in particular, but also in general, the computing unit may also be physically separated from the other components of the light microscope.

According to one embodiment, the light microscope comprises a control unit which is configured to control components of the light microscope, in particular the scanner, the illumination optics, the detection device and/or the computing unit in accordance with the method according to the present disclosure. The control unit may be combined with the computing unit in a single unit or be configured separately from it.

A third aspect of the present disclosure relates to a non-transitory computer-readable medium for storing computer instructions for localizing or tracking an emitter in a sample that, when executed by one or more processors associated with a light microscope causes the one or more processors to perform the method according to the first aspect.

Further embodiments of the light microscope according to the second aspect and of the computer program according to the third aspect result from the embodiments of the method according to the first aspect described above. Conversely, further aspects of the method according to the first aspect and of the computer program according to the third aspect result from embodiments of the light microscope according to the second aspect.

Advantageous further embodiments of the present disclosure are shown in the claims, the description and the drawings and the associated explanations of the drawings. The described advantages of features and/or combinations of features of the present disclosure are merely exemplary and can have an alternative or cumulative effect.

With regard to the disclosure (but not the scope of protection) of the original application documents and the patent, the following applies: Further features may be found in the drawings—in particular the relative arrangements and active compounds shown. The combination of features of different embodiments of the present disclosure or of features of different claims is also possible in deviation from the selected back relations of the claims and is hereby suggested. This also applies to those features which are shown in separate drawings or mentioned in their description. These features may also be combined with features of different claims. Likewise, features listed in the claims may be omitted for further embodiments of the present disclosure, but this does not apply to the independent claims of the granted patent.

In the following, embodiments of the present disclosure are described with reference to the figures. These do not limit the subject matter of this disclosure and the scope of protection.

### BRIEF DESCRIPTION OF THE FIGURES

FIG. 1 shows an example of a light microscope according to the present disclosure;

FIG. 2 shows an example of a light microscope according to the present disclosure;

FIG. 3 shows a scanner for a light microscope according to the present disclosure according to an example;

FIG. 4 shows a scanner for a light microscope according to the present disclosure according to a further example;

FIG. 5 shows a diagram illustrating an embodiment of the method according to the present disclosure with a circular path;

FIG. 6 shows an example of an emission signal obtained in the method according to the present disclosure;

FIG. 7 shows a diagram illustrating an embodiment of the method according to the present disclosure with a loop-shaped path;

FIG. 8 shows a diagram illustrating an embodiment of the method according to the present disclosure with a rosette-shaped path;

FIG. 9 shows a diagram illustrating an embodiment of the method according to the present disclosure with a path in the form of a Lissajous figure.

### DESCRIPTION OF THE FIGURES

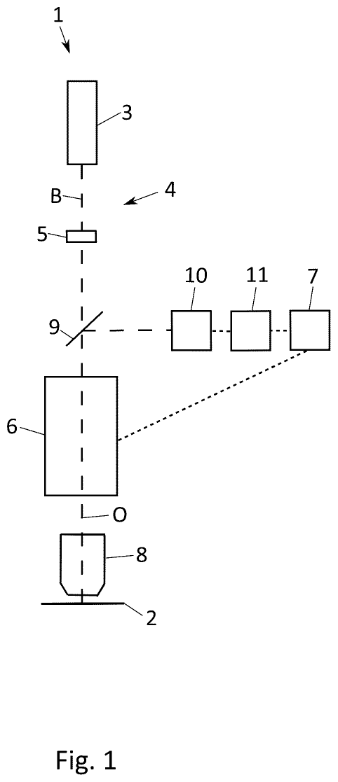

FIG. 1 shows an example of a light microscope 1 according to the present disclosure, namely a MINFLUX microscope, comprising a light source 3, in particular a laser, which generates an illumination light beam B, wherein the illumination light beam B is in particular an excitation light beam which excites emitters E in a sample 2 to emit light, in particular luminescence emission, further in particular fluorescence emission.

The illumination light beam B passes through illumination optics 4, comprising a light modulator 5, e.g. a phase filter or a spatial light modulator with controllable pixels. In particular, the light modulator 5 modulates the phase of the illumination light beam B in such a way that an intensity distribution of the illumination light with a central intensity minimum, i.e. located on an optical axis O of the illumination light beam B, is formed at the focus in the sample 2 by interference.

Via a beam splitter 9, which separates the illumination light from the emission light emitted by the sample 2, the illumination light beam B reaches a scanner 6, which displaces the illumination light beam B relative to the sample 2. The scanner 6 is configured in particular as a mechanical scanner, e.g. as a galvanometer scanner.

A control unit 7 is connected to the scanner 6 and provides the scanner 6 with control signals which determine the states of at least one optical component of the scanner 6, e.g. a rotatable mirror, to displace the intensity distribution, i.e. its local minimum, on a path, in particular a continuous path, around an expected position of the emitter in the sample 2.

The illumination light beam B is focused by an objective 8 into the sample 2 to form the intensity distribution of the illumination light with the central minimum.

Emitters in the sample 2 that are excited by the illumination light emit emission light, in particular fluorescent light, which is collected by the objective 8 to form an emission light beam and scanned by the scanner 6. The emission light beam is then reflected at the beam splitter 9 into a detection beam path, where a detection device 10, in particular a point detector such as an APD or a spatially resolving detector such as an APD array, is arranged.

The detection device 10 detects and registers light emissions L emitted by the emitter E in the sample 2 in a time-resolved manner and generates an emission signal S from the registered light emissions L.

The detection device 10 is coupled to a computing unit 11, which evaluates a temporal modulation of the emission signal S formed from light emissions and estimates a position of the emitter E in the sample 2 from this. For this purpose, the computing unit 11 may, for example, determine Fourier coefficients formed based on a circular frequency of the movement of the intensity distribution around the expected position of the emitter E and estimate the position of the emitter E based on the Fourier coefficients. Alternatively, the computing unit 11 may, for example, also perform a phasor analysis in order to estimate the position of the emitter E.

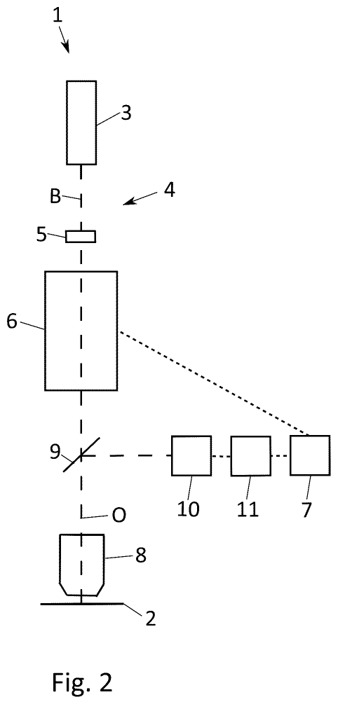

FIG. 2 shows a further embodiment of a light microscope 1 according to the present disclosure, in which the scanner 6 is arranged in the illumination beam path between the light source 3 and the beam splitter 9, so that the scanner 6 does not de-scan the emission light emitted by the sample 2 (so-called non-descanned setup). In this case in particular, the scanner 6 may also be an electro-optical deflector, for example. Apart from the position of the scanner 6 in the beam path, the components and functions of the light microscope 1 are identical to the components and functions shown in FIG. 1 and described above. Identical components are marked with identical reference signs.

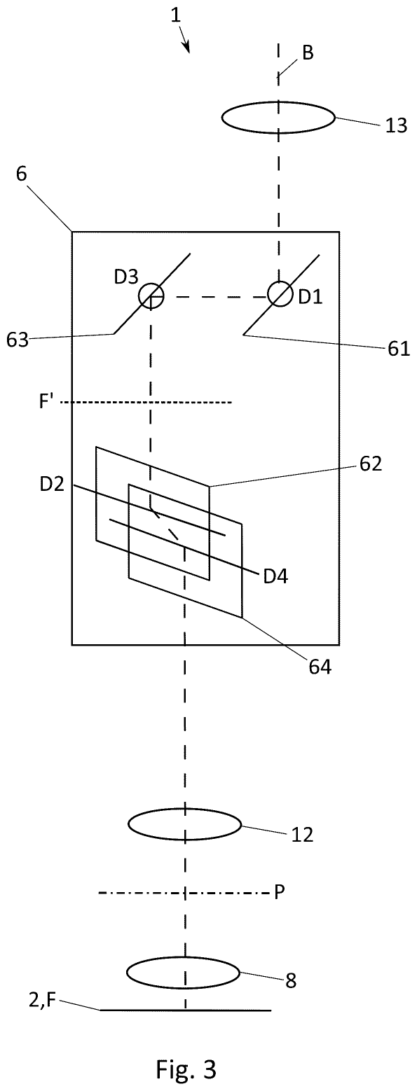

FIG. 3 shows a first example of a scanner 6 (here a beam scanner) for a light microscope 1 according to the present disclosure, a form of galvanometer scanner known as a quad scanner with four optical components 61,62,63,64, which are each configured as rotatable mirrors coupled to a galvo drive. The optical components are driven by the respective galvo drive and are each rotatable about axes of rotation D1,D2,D3,D4. The first axis of rotation D1 of the first optical component 61 and the third axis of rotation D3 of the third optical component 63 are parallel to each other and the second axis of rotation 62 of the second optical component 62 and the fourth axis of rotation 64 of the fourth optical component 64 are also parallel to each other. The first optical component 61 and the third optical component 63 jointly deflect the illumination light beam B in a first spatial direction x relative to the sample 2 and the second optical component 62 and the fourth optical component 64 jointly deflect the illumination light beam B in a second spatial direction y relative to the sample 2. In the example shown in FIG. 3, the illumination light beam B is deflected successively by the first optical component 61, the third optical component 63, the second optical component 62 and the fourth optical component 64. However, this is only one of many possible configurations.

Between the third optical component 63 and the second optical component 62 there is an image plane F′ which is conjugate to a focal plane F in the sample 2. In other words, the objective lens 8 and a tube lens 12 form an optical relay that images the focal plane F into the image plane F′ within the scanner 6. A focusing lens 13 focuses the illumination light beam B emitted by the light source 3 into this image plane F′.

The first optical component 61 and the third optical component 63 are controlled in particular in such a way that the illumination light beam B always hits the same point in a pupil P (back aperture) of the objective lens 8 regardless of the position of the rotatable mirrors. Different deflections then only lead to a tilting of the illumination light beam B in the pupil P, which results in a lateral displacement of the focus in the sample 2 in the first spatial direction x due to the focusing by means of the objective lens 8. The same principle also applies in particular to the deflection in the second spatial direction y.

This has the advantage, particularly for MINFLUX microscopy, that the intensity distribution of the illumination light B in the sample 2 remains constant regardless of its lateral position.

If the optical components are to be controlled in such a way that the illumination light beam B hits the same point in the pupil P of the objective 8 for each deflection, the first optical component 61 and the third optical component 63 are controlled in particular together with a first control signal that determines the displacement of the intensity distribution in the first spatial direction x. The same applies in particular to the second optical component 62 and the fourth optical component 64 with respect to the second spatial direction y.

In particular, if small shifts in the pupil P are tolerable, e.g. because the resulting deformations of the intensity distribution are negligibly small, or because the resulting effects on the emission signal for the various positions of the intensity distribution, in particular those distributed symmetrically around a center, are averaged out, only the first optical component 61 or only the third optical component 63 may also be subjected to the control signal in order to achieve the deflection of the intensity distribution in the first spatial direction x, while the other optical component 61 or 63 is kept at rest or performs a defined movement (in particular of lower frequency and/or amplitude). This applies analogously to the control of the second optical component 62 or the fourth optical component 64.

In the latter cases described, when using the configuration shown in FIG. 3, it is favorable to control only the first optical component 61 and the fourth optical component 64, since these optical components are furthest away from the image plane F′, and thus the same amplitude of movement of the intensity distribution in the sample 2 can be achieved with a lower amplitude of rotation of the optical components about the respective axes of rotation (a smaller stroke).

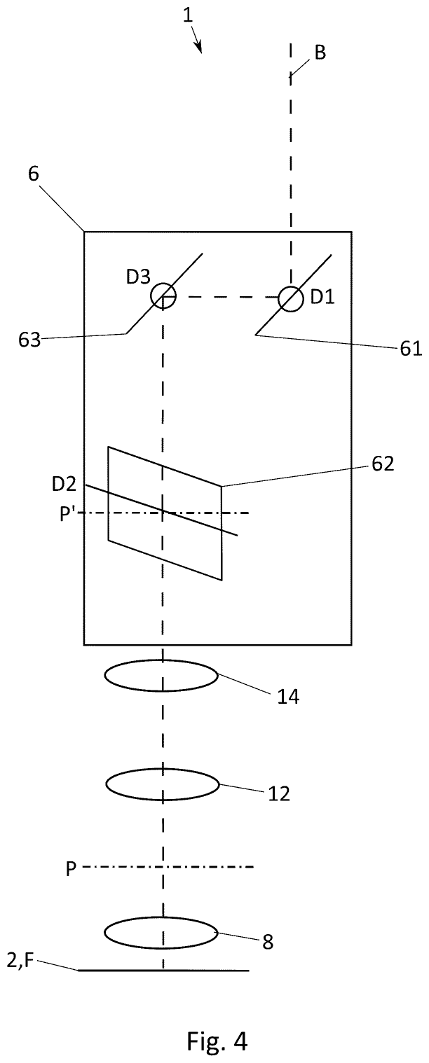

FIG. 4 shows a further example of a scanner 6 (a beam scanner) for the light microscope 1 according to the present disclosure, a variant of a galvanometer scanner known as a tandem scanner, pupil scanner or x2y scanner.

The scanner 6 comprises a first optical component 61 rotatable about a first axis of rotation D1, a second optical component 62 rotatable about a second axis of rotation D2 and a third optical component 63 rotatable about a third axis of rotation D3, each of which is configured as a mirror coupled to a galvanometer drive.

The illumination light beam B is successively deflected by the first optical component 61, the third optical component 62 and the second optical component 62. However, other arrangements are of course also possible.

The first optical component 61 and the third optical component 63 jointly deflect the illumination light beam B in a first spatial direction x and the second optical component deflects the illumination light beam B in a second spatial direction y.

In the scanner 6 shown in FIG. 4, the second optical component 62 is arranged in a pupil plane P′. This is realized by imaging the pupil P (back aperture) of the objective lens 8 through the tube lens 12 and a scanning lens 14.

According to a variant of the scanner 6 shown in FIG. 4, the second optical component 62, which deflects the illumination light beam B in the second spatial direction y, is a rotatable mirror of a resonant mechanical scanner, while the first optical component 61 and the third optical component are rotating mirrors coupled to galvo motors. In this case, the second optical component 62 in particular is subjected to the control signal with the highest frequency.

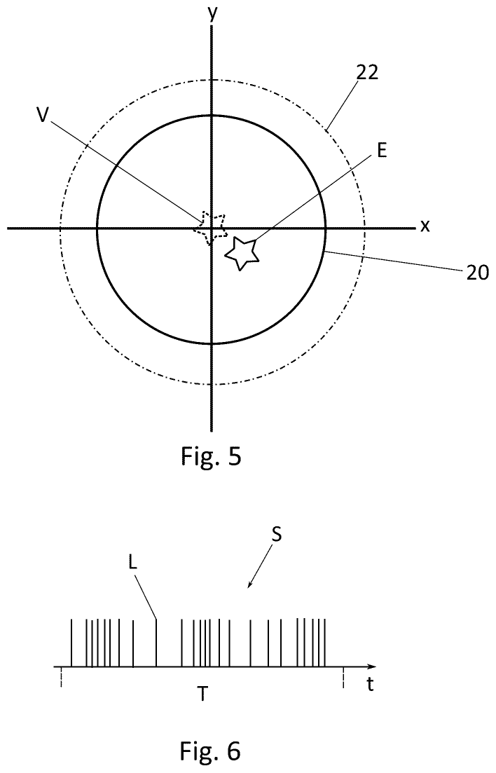

FIG. 5 schematically shows an example of the method according to the present disclosure, in which an intensity distribution of the illumination light with a central minimum on a path 20 in the sample 2 is displaced in a close region 22 of a presumed position V of an emitter E. The close region 22 can be, for example, a circle with a diameter which is the optical diffraction limit under the given conditions (in particular wavelength of the illumination light, emission spectrum of the emitter, numerical aperture of the objective). The presumed position V is shown as a star with dashed lines, the actual position of the emitter E as a star with solid lines.

In the example shown in FIG. 5, the path 20 is circular, with the center of the circle at the presumed position V of the emitter E.

Furthermore, it can be seen from FIG. 5 that the presumed position V deviates from the actual position of the emitter E, so that the time course of the light emissions L of the emitter E (in particular the time course of the probability that the emitter E emits a photon at a given time) is modulated on the time scale of the movement of the intensity distribution on the path 20.

FIG. 6 shows an example of the temporal progression of an emission signal S in a measurement time interval T, wherein the emission signal S consists of individual light emissions L of the emitter E registered by a detector.

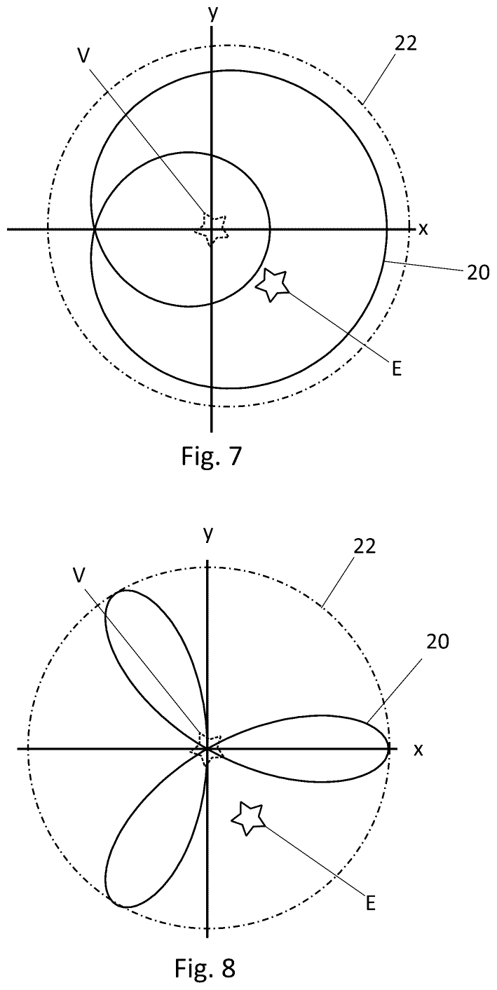

FIG. 7 schematically shows a further embodiment of the method according to the present disclosure, in which the intensity distribution of the illumination light in a close range 22 is moved on a non-circular path 20 around the presumed position V of the emitter E (dashed star). The actual position of the emitter E is symbolized by a star with solid lines as in FIG. 5.

The path 20 here is a Pascal's snail, a subform of the path 20 referred to in the present application as a loop, which belongs to the hypotrochoids and can be described mathematically by the time course of the x-coordinate in the focal plane according to the formula x=L₁/2·cos(ω₁ t)+L₂/2·cos(ω₂ t) and the time course of the y-coordinate in the focal plane according to the formula y=L₁/2·sin(ω₁ t)+L₂/2·sin(ω₂ t). In the specific example shown, the conditions ω₁=2ω₂ and L₂=2L₁ apply.

FIG. 8 is a diagram of a further embodiment of the method according to the present disclosure, in which the intensity distribution of the illumination light in a close range 22 is moved on a non-circular path 20 around the presumed position V of the emitter E (dashed star). The actual position of the emitter E is symbolized by a star with solid lines as in FIG. 5.

The path 20 shown in FIG. 8 is a so-called rosette or cloverleaf curve, another subtype of hypotrochoids. Such paths 20 can be described mathematically by the time course of the x-coordinate in the focal plane according to the formula x=L₁^{x}/2·cos(ω₁^{x} t)+L₂^{x}/2·cos(ω₂^{x} t) and the time course of the y-coordinate in the focal plane according to the formula y=L₁^{y}/2·sin(ω₁^{y} t)−L₂^{y}/2·sin(ω₂^{y} t). In the specific example shown, the frequency ratios are ω₁^{x}/ω₂^{x} and ω₁^{y}/ω₂^{y} are each 2/1 and the amplitudes L₁^{x}/2, L₂^{x}/2, L₁^{y}/2 and L₂^{y}/2 are identical.

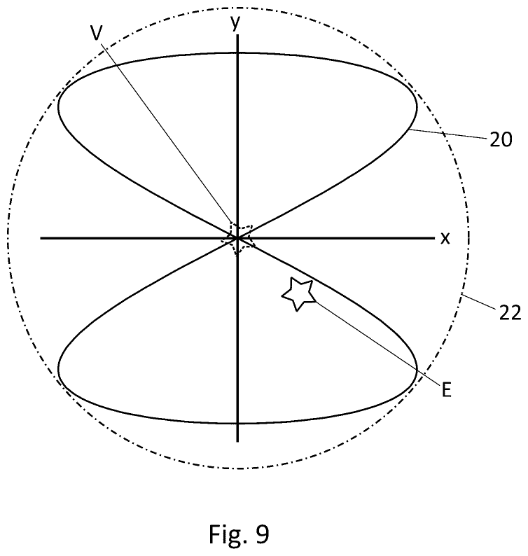

FIG. 9 schematically illustrates a further embodiment of the method according to the present disclosure, in which the intensity distribution of the illumination light in a close range 22 is moved on a non-circular path 20 around the presumed position V of the emitter E (dashed star). As in FIG. 5, the actual position of the emitter E is symbolized by a star with solid lines. The path 20 according to FIG. 9 is a Lissajous figure.

Such paths 20 can be mathematically described by the course of the x-coordinate in the focal plane according to the formula x=Lₓ/2 (sin ω₁ t) and the course of the y-coordinate in the focal plane according to the formula y=L_{y}/2 (sin ω₂ t). In the example shown, ω₁=2ω₂ applies to the frequencies and Lₓ/2=L_{y}/2 to the amplitudes.

The paths 20 shown in FIG. 5 and FIG. 7 to FIG. 9 may be generated, for example, with the light microscope 1 shown in FIG. 1 or FIG. 2, by generating an illumination light beam B of the illumination light by means of the light source 3 (e.g. a laser), phase-modulating it by the light modulator 5 (e.g. a spatial light modulator or a phase plate), e.g. with a vortex phase pattern, focusing it by the objective 8 into the sample 2, so that (possibly after circular polarization of the light beam) a donut-shaped intensity distribution of the illumination light is created at the focus in the sample 2, wherein the intensity distribution is displaced by the scanner 6 (e.g. a galvanometer scanner) in the sample 2 on the path 20. For example, control signals for the individual movable mirrors of the galvanometer scanner may correspond to the mathematical descriptions of the x and y coordinates of the intensity distribution given above for the various paths 20 or be derived from these. The illumination light may be excitation light, for example, which excites emitters E in the sample to fluoresce. The fluorescence photons emitted by the emitter E may then be detected and registered during the measurement period by the detection device 10 (e.g. comprising at least one avalanche photodiode, APD) in order to obtain, for example, the emission signal S shown in FIG. 6, which is modulated in time by the movement of the intensity distribution on the path. It may then be evaluated by the computing unit 11, e.g. as described below, in order to estimate the position of the emitter E in the sample 2.

In the following, various examples of the evaluation of the temporal modulation of the emission signal obtained in the method according to the present disclosure caused by the displacement of the intensity distribution on the path 20 are described, with which the position of the emitter E in the sample 2 may be estimated.

According to a first variant of the evaluation, a Fourier analysis of the emission signal S is carried out, which can in principle be applied both to a circular path 20 of the intensity distribution (see e.g. FIG. 5) and to a non-circular path 20 of the intensity distribution (see e.g. FIG. 7 to FIG. 9).

For a simpler explanation of the basic principle of the method, a 2D localization in the focal plane in the sample 2 is assumed in the following, in which the intensity distribution of the illumination light is displaced with a circular frequency ω on a circular path 20 with a radius L/2 around a center located at the presumed position V of the emitter E (see FIG. 5). However, the position estimation according to the present disclosure is of course also applicable for three-dimensional paths of the intensity distribution around the presumed position V of the emitter E as well as for two-dimensional non-circular paths (see below).

In the case of a representation in Cartesian coordinates with an origin at the presumed position V of the emitter E (see FIG. 5), the time course of the x-coordinate of the local minimum of the intensity distribution in the case of 2D localization can be described by the equation x=L/2·cos ω t and the time course of the y-coordinate by the equation y=L/2·sin ω t where L denotes the diameter of the circle or twice the amplitude of the sinusoidal or cosinusoidal time course of the local coordinates.

The local progression of the intensity distribution of the illumination light is assumed to be parabolic, which is a good approximation for a donut-shaped intensity distribution near the local minimum, for example. For the local progression of the light intensity along the x-coordinate, Iₓ(t)=a·x2 therefore approximately applies, and I_{y}(t)=a·y² correspondingly for the course along the y-coordinate. The parameter a is a so-called shape parameter of the intensity distribution, which here describes the steepness of the parabolic intensity curve around the local minimum at the origin of the coordinate system. The parameter a depends (in the simplest case linearly) on the total intensity of the intensity distribution and thus on the power of the illumination light. For the following considerations in the context of the first variant, it is assumed for the sake of simplicity that the shape parameter a is known in advance or can be determined by an independent measurement or estimate (in further variants of the method according to the present disclosure, the shape parameter a is estimated from the emission signal in addition to the position of the emitter, see below).

Furthermore, it is assumed that there is a linear relationship between the intensity of the illumination light acting on the emitter E and its emission rate.

Thus the following expression for the temporally modulated emission signal can be obtained by inserting the time course of the intensity distribution on the path into the equation for the local progression of the intensity distribution: E(t)∝a(x−L/2 cos(ωt+φ))²+a(y−L/2 sin(ωt+φ))², wherein x and y are the x and y coordinates of the actual position of the emitter, and wherein φ is a phase shift between the movement of the intensity distribution on the path and the zero point of the measurement period of the detection device. The phase shift can be neglected due to the possibility of synchronization between the scanner and the detection device (by tuning during the measurement or subsequently by data processing). Any proportionality factor between emission rate and illumination light intensity can also be included in the shape parameter a so that a simplified expression results:

$$E ( t ) = a {( x - \frac{L}{2} cos ( ω t ) )}^{2} + a {( y - \frac{L}{2} sin ( ω t ) )}^{2} .$$

From this expression for E(t) the first coefficients x and y of the Fourier series can be determined as follows:

$$\hat{x} = {\int }_{0}^{2 N π / ω} E ( t ) cos ω t dt = - \frac{a N π L}{ω} \cdot x$$

$$\hat{y} = {\int }_{0}^{2 N π / ω} E ( t ) sin ω t dt = - \frac{a N π L}{ω} \cdot y$$

Here N is a natural number.

By rearranging, estimates for the x-coordinate and the y-coordinate of the emitter E are obtained:

$$x = - \frac{ω}{a N π L} \hat{x} \\ y = - \frac{ω}{a N π L} \hat{y}$$

The Fourier coefficients \hat{x} and ŷ can be determined numerically from the emission signal, e.g. using an FFT (Fast Fourier Transform) algorithm. The circular frequency ω and the radius L/2 are already known, the parameter N (number of periods to be integrated) can be freely selected and the parameter a is also assumed to be known, as explained above. In particular, a computation unit, e.g. an FPGA or an electronic circuit, can be used to multiply the emission signal with cos ωt resp. sin ωt (also known as scanner offset) and integrate at least one orbit. As described above, this can be used to obtain a position estimate for one coordinate at a time, from which a positioning signal for the scanner can then be derived, e.g. based on a comparison of the previously presumed position and the newly estimated position. In particular, the position of the emitter may also be derived after several such steps from the center of the last path according to a suitable termination criterion. Alternatively, several positioning signals (possibly weighted) may be added together to obtain the final position estimate of the emitter. After a partial step in which a positioning signal is obtained, the radius L/2 of the path may in particular also be reduced and/or the overall intensity of the illumination light may be increased so that the shape parameter a changes. Such parameter adjustments can be made, for example, depending on the total number of light emissions detected over a cycle, e.g. the total intensity can be increased if the total number of light emissions falls below a threshold value.

In a second variant of the evaluation, in addition to the position of the emitter E, a further parameter, namely the shape parameter a, is estimated. In the example explained here, the path of the intensity distribution is circular and the local course of the intensity of the illumination light is approximated by a parabola. Of course, the principle of the method may also be applied to non-circular paths 20 and other intensity curves.

In addition to the Fourier coefficients \hat{x} and ŷ the total number \hat{n} of light emissions is determined from the emission signal via one or more orbits of the intensity distribution around the presumed position of the emitter E. For \hat{n} the above assumptions analytically result in the expression

$$\hat{n} = {\int }_{0}^{2 N π / ω} E ( t ) dt = a π \frac{{L}^{2} + 4 {x}^{2} + 4 {y}^{2}}{2 ω} .$$

Together with the expressions

$$\hat{x} = - \frac{a N π L}{ω} \cdot x and \hat{y} = - \frac{a N π L}{ω} .$$

y this gives a total of three equations. By solving this system of equations, the three unknowns x, y and a can be determined. This means that the position of the emitter can be reliably estimated even if the shape parameter of the intensity distribution is unknown in advance.

In a third variant of evaluating the emission signal, phasor analysis can be used to estimate an angular coordinate φ and a radial coordinate of the actual position of the emitter E relative to the presumed position V of the emitter E can be estimated by means of phasor analysis. For this purpose, as in the first variant and the second variant, the Fourier coefficients \hat{x} and ŷ are determined.

From these, the phase angle can be determined according to the equation φ=tan⁻¹ŷ/\hat{x}. Determining the angular coordinate φ may already be sufficient to provide a positioning signal for the scanner and to move the center of the path 20 gradually closer to the actual position of the emitter E if the step size is suitably selected. In addition, a radial coordinate ρ of the estimated position of the emitter can be determined using the equation

$$ρ = \frac{\sqrt{{\hat{x}}^{{}_{2}} + {\hat{y}}^{{}_{2}}}}{\hat{n}}$$

if, as in the second variant, the total number \hat{n} of light emissions during one or more orbits of the intensity distribution around the presumed position V of the emitter is determined. An advantage of the third variant of the evaluation is that the shape parameter a can be derived from the equations for φ and ρ and the position determination is therefore independent of the shape parameter a, i.e. it can also be carried out with unknown a.

In a fourth variant of the evaluation of the emission signal, different emission signals are used which were obtained with different paths 20 or different parameters of the path 20 of the intensity distribution of the illumination light around the presumed position of the emitter. For example, the radius L/2 of a circular path 20 can be adjusted and emission signals can be recorded during different measurement time intervals that correspond to different radii L₁/2 and L₂/2. This has the advantage that, in addition to the position of the emitter E in the sample, additional parameters such as a shape parameter a of the intensity distribution and a parameter representing the background b can be estimated.

For example, for a parabolic shape of the intensity distribution under conditions with background (E(t)=a·[(x−Iₓ(t))²+(y−I_{y}(t))²]+b) Fourier coefficients from a superposition of two emission signals E (L₁) and E (L₂) can be formed as follows:

$$\hat{x} = {\int }_{0}^{2 N π / ω} {E}_{L 1} ( t ) cos ( ω t ) dt + {\int }_{0}^{2 N π / ω} {E}_{L 2} ( t ) cos ( ω t ) dt = - \frac{a N π ( {L}_{1} + {L}_{2} )}{ω} x$$

$$\hat{y} = {\int }_{0}^{2 N π / ω} {E}_{L 1} ( t ) sin ( ω t ) dt + {\int }_{0}^{2 N π / ω} {E}_{L 2} ( t ) sin ( ω t ) dt = - \frac{a N π ( {L}_{1} + {L}_{2} )}{ω} y$$

In addition, the sums of the light emissions in the respective measurement time interval can be calculated separately for the two radii L1 and L2:

$${\hat{n}}_{1} = {\int }_{0}^{2 N π / ω} {E}_{L 1} ( t ) dt = π \frac{a ( {L}_{1}^{2} + 4 {x}^{2} + 4 {y}^{2} ) + 4 b}{2 ω} \\ {\hat{n}}_{2} = {\int }_{0}^{2 N π / ω} {E}_{L 2} ( t ) dt = π \frac{a ( {L}_{2}^{2} + 4 {x}^{2} + 4 {y}^{2} ) + 4 b}{2 ω}$$

In this way, four equations are obtained by means of which the four unknowns x, y, a and b can be determined.

In a fifth variant of the evaluation according to the present disclosure, an emission signal is used whose temporal modulation is created by shifting the intensity distribution on a non-circular path, wherein the path is characterized by several circular frequencies that are in a fixed relationship to each other. Examples of such paths are hypotrochoids (see FIG. 7 and FIG. 8) with several different circular frequencies with respect to the x-coordinate and the y-coordinate and Lissajous figures (see FIG. 9) with one circular frequency each for the x-coordinate and the y-coordinate, wherein the circular frequencies are different and are in a fixed ratio to each other.

In the fifth variant, further parameters such as shape parameters of the intensity distribution and a parameter representing the background can also be estimated due to the different circular frequencies contained in the path, but by means of a closed path, i.e. without abrupt changes in the control parameters for the scanner.

During the evaluation, it is utilized that the intensity distribution orbits the presumed position V of the emitter E in the sample 2 several times within a closed path 20. The entire path 20 is therefore characterized by several periodic movements with respect to the individual position coordinates. The emission signal is now integrated separately over these sections in order to obtain linearly independent equations.

The evaluation according to the fifth variant is illustrated below as an example for a special rosette-shaped path with three leaves, wherein the temporal change of the spatial coordinates x and y can be described by the following equations:

$$x = L / 2 \cdot cos ( ω t ) + L / 2 \cdot cos ( 1 / 2 \cdot ω t ) \\ y = L / 2 \cdot sin ( ω t ) - L / 2 \cdot sin ( 1 / 2 \cdot ω t )$$

L/2 here denotes the amplitude of the movement in the two spatial directions x and y in analogy to the circle radius. In this case, there is a frequency ratio of 2:1 and an amplitude ratio of 1:1.

Assuming a parabolic shape of the intensity distribution near the local minimum and taking into account the background (parameter b) the following is obtained:

$$E ( t ) = a [ ( x - \frac{L}{2} {( cos ω t + cos 1 / 2 \cdot ω t )}^{2} + ( y - \frac{L}{2} {( sin ω t - sin ( 1 / 2 \cdot ω t ) )}^{2} ] + b$$

For each spatial direction, in addition to the Fourier coefficients determined by integration from 0 to 2π, several different expressions for the corresponding total numbers of light emissions can now be determined by integration over subintervals \hat{n}₁, \hat{n}₂.

$$\hat{x} = {\int }_{0}^{2 π / ω} E ( t ) cos ( ω t ) dt = - \frac{6 π Lax + 8 Lay}{6 ω} \\ \hat{y} = {\int }_{0}^{2 π / ω} E ( t ) sin ( ω t ) dt = - \frac{15 π Lay + 12 {L}^{2} a + 40 Lax}{15 ω} \\ {\hat{n}}_{1} = {\int }_{0}^{π / ω} E ( t ) dt = \frac{3 π {L}^{2} a - 2 {L}^{2} a + 6 π a {y}^{2} + 6 π a {x}^{2} - 12 Lax + 6 π b}{6 ω} \\ {\hat{n}}_{2} = {\int }_{π / ω}^{2 π / ω} E ( t ) dt = \frac{3 π {L}^{2} a + 2 {L}^{2} a + 6 π a {y}^{2} + 6 π a {x}^{2} + 12 Lax + 24 Lay + 6 π b}{6 ω}$$

The resulting system of equations can be solved for x, y, a and b with the measured values of \hat{x}, ŷ (Fourier transform of the emission signal) and \hat{n}₁ and \hat{n}₂ sums of light emissions in the corresponding sub-intervals of the measurement time interval.

In the fifth variant (and analogous embodiments), care must be taken when transferring to other orbits that the integration limits are selected in such a way that non-linearly dependent equations for \hat{n}₁ and \hat{n}₂ are obtained.

### LIST OF REFERENCE SYMBOLS

1 Light microscope
2 Sample
3 Light source
4 Illumination optics
Light modulator
6 Scanner
7 Control unit
8 Objective/objective lens
9 Beam splitter
Detection device
11 Computing unit
12 Tube lens
13 Focusing lens
14 Scan lens
Path
22 Close range
61 First optical component
62 Second optical component
63 Third optical component
64 Fourth optical component
B Illumination light beam
D1,D2,D3,D4 Axis of rotation
E Emitter
F Focal plane
F Image plane
L Light emission
O Optical axis
P Pupil
P Pupil plane
S Emission signal
T Measuring time interval
V Presumed position

1. A method for localizing or tracking an emitter in a sample, wherein the sample is illuminated with an intensity distribution of illumination light comprising a local intensity minimum, wherein the illumination light affects light emissions of the emitter, and wherein the intensity distribution is displaced on a path around a presumed position of the emitter,
wherein light emissions of the emitter are detected in a time-resolved manner in a measurement time interval to obtain an emission signal, wherein a position of the emitter in the sample is estimated based on a temporal modulation of the emission signal caused by the displacement of the intensity distribution on the path, and wherein the intensity distribution is displaced relative to the sample by means of a mechanical scanner.

2. The method according to claim 1, wherein at least one spatial coordinate of the emitter is estimated by means of Fourier analysis of the emission signal.

3. The method according to claim 2, wherein estimated values for a first spatial coordinate of the emitter and a second spatial coordinate of the emitter are determined from the emission signal based on the formulae \hat{x}=∫₀^{N·2π/ω} E(t)·cos(k·ω t) dt and ŷ=∫₀^{N·2π/ω} E(t)·sin(k·ω t) dt, wherein E(t) denotes the emission signal, t denotes the time, ω denotes a circular frequency of the movement of the intensity distribution on the path, and N and k are natural numbers, wherein a local intensity profile of the intensity distribution is used as a basis for determining the first spatial coordinate and the second spatial coordinate.

4. The method according to claim 3, wherein the emission signal is represented by the formula E(t)=a·[(x−Iₓ(t))^{c}+(y−I_{y}(t))^{c}] or the formula E(t)=a·[(x−Iₓ(t))^{c}+(y−I_{y}(t))^{c}]+b, wherein x is the first spatial coordinate of an actual position of the emitter, wherein y is the second spatial coordinate of the actual position of the emitter (E), wherein Iₓ(t) describes a temporal change of the first spatial coordinate caused by the movement of the intensity distribution on the path, wherein I_{y}(t) describes a temporal change of the second spatial coordinate caused by the movement of the intensity distribution on the path, wherein a describes a first shape parameter of the intensity distribution, wherein c describes a second shape parameter of the intensity distribution, and wherein b describes a parameter representing the background.

5. The method according to claim 3, wherein the temporal change of the first spatial coordinate and the temporal change of the second spatial coordinate are each represented by a sine function or cosine function.

6. The method according to claim 3, wherein the temporal change of the first spatial coordinate and the temporal change of the second spatial coordinate are each represented by a weighted sum of sine functions and/or cosine functions.

7. The method according to claim 5, wherein the sine functions and/or the cosine functions have different circular frequencies which are in a fixed ratio to each other.

8. The method according to claim 1 wherein the path can be described by a superposition of different circular frequencies, wherein additional information is obtained by means of an evaluation of the emission signal, wherein the additional information is used to determine estimated values for further parameters in addition to the position of the emitter.

9. The method according to claim 8, wherein the estimated values for the further parameters comprise an estimated value for a shape parameter of the intensity distribution and/or an estimated value for background.

10. The method according to claim 8, wherein integrals are calculated over the emission signal over different integration limits to determine the estimated values for the further parameters.

11. The method according to claim 1, wherein an angular coordinate of the emitter is estimated by means of phasor analysis of the emission signal, and wherein the estimation of the angular coordinate is based on a local intensity profile of the intensity distribution.

12. The method according to claim 11, wherein a radial coordinate of the emitter is further estimated by means of the phasor analysis.

13. The method according to claim 1, wherein a radius of a circular path of the intensity distribution around the presumed position of the emitter is adapted, wherein a plurality of emission signals are determined from respective light emissions, the light emissions being assigned to different radii of the path, wherein the position of the emitter is estimated based on temporal modulations of the plurality of emission signals.

14. The method according to claim 1, wherein the intensity distribution is displaced on a non-circular path around the presumed position of the emitter, wherein the path comprises subsections which lie approximately on circles with different radii around the presumed position of the emitter, wherein a plurality of emission signals are determined from light emissions assigned to the respective subsections, and wherein the position of the emitter is estimated based on temporal modulations of the plurality of emission signals.

15. The method according to claim 1, wherein a power of the illumination light is varied, wherein a plurality of emission signals are determined from light emissions respectively obtained at the same power, and wherein the position of the emitter is estimated based on temporal modulations of the plurality of emission signals.

16. The method according to claim 13, wherein an estimated value for a shape parameter of the intensity distribution and/or an estimated value for background is additionally determined based on the plurality of emission signals.

17. The method according to claim 1, wherein after estimating the position, a renewed position determination of the emitter is carried out, wherein the intensity distribution of the illumination light is displaced on a path around the previously estimated position of the emitter during the renewed position determination, wherein further light emissions of the emitter are detected in a time-resolved manner in a further measurement time interval, and wherein a further emission signal is obtained from the light emissions detected in the further measurement time interval, and wherein the position of the emitter is estimated again based on a temporal modulation of the further emission signal caused by the displacement of the intensity distribution on the path around the previously estimated position.

18. The method according to claim 17, wherein a parameter of the intensity distribution and/or a parameter of the path is adapted for the renewed position determination.

19. A light microscope for localizing or tracking an emitter in a sample comprising
a. illumination optics configured to illuminate the sample with an intensity distribution of illumination light comprising a local intensity minimum, wherein the illumination light affects light emissions of the emitter,
b. a scanner which is configured to displace the intensity distribution on a path around a presumed position of the emitter,
c. a detection device configured to detect light emissions of the emitter in a time-resolved manner in a measurement time interval to obtain an emission signal, and
d. a computing unit configured to estimate a position of the emitter in the sample based on a temporal modulation of the emission signal caused by the displacement of the intensity distribution on the path.

20. A non-transitory computer-readable medium for storing computer instructions for localizing or tracking an emitter in a sample that, when executed by one or more processors associated with a light microscope causes the one or more processors to perform a method according to claim 1.
